(19) United States
(12) Patent Application Publication
(10) Pub. No.: US 2006/0248041 A1
(43) Pub. Date: Nov. 2, 2006

(54) Computing environment assurance tool

(76) Inventor: Will Stevenson, Englewood, CO (US)

Correspondence Address: HENSLEY KIM & EDGINGTON, LLC, 1660 LINCOLN STREET, SUITE 3050, DENVER, CO, 80264, US

(21) Appl. No.: 11/366,206

(22) Filed: Mar. 1, 2006

Related U.S. Application Data
(60) Provisional application No. 60/657,838, filed on Mar. 1, 2005.

(51) Int. Cl. G06F 17/30

(52) U.S. Cl. 707/1

(57) ABSTRACT

A user's computing environment, including operating system, programs, settings, and user data, is stored on a secondary storage device. The computer's operating system is reconfigured such that user data access requests are routed to the user data on the secondary storage device. From a user's perspective, the location of his or her user data within the computing environment appears not to have changed. Backup and restoration of the computing environment is easily effectuated from the secondary storage device.

### CROSS-REFERENCE TO RELATED APPLICATIONS

This application claims benefit of U.S. Provisional Application No. 60/657,838, entitled “General Purpose Operating Environment Assurance Tool” and filed on Mar. 1, 2005, which is specifically incorporated herein by reference for all that it discloses and teaches.

### TECHNICAL FIELD

The invention relates generally to computer software and systems, and more particularly to a computing environment assurance tool.

### BACKGROUND

Currently, a computer user is locked into a single, primary computer because the user's programs, settings, and information are stored on the single, primary computer. If the computer fails, the user's computing environment is no longer available. A computer user may use two or more computers, but each of the individual computers typically contains programs, settings, and/or information that are different from those on the other computer(s). Consequently, failure of just one of the computers means the loss of at least a portion of the user's software and data. Even if the user has performed a backup operation, the recovery process can be cumbersome and typically fails to provide up-to-the-minute backup and restoration of the user's software and data.

Furthermore, users cannot easily move from computer to computer. For example, laptop computers are extremely popular because professionals, students and others need to transport their computing environments between work/class and home. Today, portable computers are a primary option to address this need. However, portable computers can be low-powered, bulky and difficult to transport. Other users address this need through the use of portable data devices such as removable hard drives. These solutions, although usually less bulky and more easily transportable than laptop computers, often have problems with configuration and synchronization. Furthermore, conventional removable drive technologies add complexity to the computing environment because of the additional drive letter and storage location choices they present to the user. Other solutions, such as Web hosted environments, have other disadvantages, including, for example, a need to be connected to the Web host and a lack of full software and operating system recovery.

### SUMMARY

Implementations described and claimed herein address the foregoing problems by functionally separating data into three basic computing categories: executable data, settings data, and user data. Executable data includes instructions that execute in memory; settings data configures how the executable data runs; and user data represents input, output, and intermediate information with which the executable data operates. Functionally separating these three categories of data allows definition of a computing assurance model by which major computing components contributing to the general purpose computing environment are made transparent, recoverable, and available.

A user's complete computing environment is stored on a secondary storage medium. The secondary storage medium can be removable, detachable, remote, or otherwise portable or separable from the primary computer. User data is relocated to the secondary storage medium, and the computer's operating system is reconfigured such that access requests for user data are automatically routed to the secondary storage medium. Executable and settings data may be imaged to the secondary storage medium, thereby providing convenient backup and restoration of the executable and settings data from the secondary storage medium. Such imaging can be repeated at various intervals to provide updated backups.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave or other communication media by a computing system and encoding the computer program.

Some implementations include a method of managing data in a computing environment, the data including executable data, settings data, and user data, the method involving: identifying a user data reference in the computing environment that references a located set of user data on the first storage medium, the user data reference having a user-perceivable label; changing the user data reference to reference a second storage location on a second storage medium, wherein the user-perceivable label is unchanged; and relocating the set of user data to the second storage location on the second storage medium.

Some implementations involve a method of structuring data in a computing environment, the data including executable data, settings data, and user data, the method including: identifying a set of user data on a first storage medium; identifying a set of settings data on the first storage medium; identifying a set of executable data on the first storage medium; changing one or more pointers for the set of user data on the first storage medium to reference a second storage medium; relocating the set of user data referenced by the one or more pointers from the first storage medium to the second storage medium; modifying the computing environment such that the set of user data appears not to have been relocated; imaging the set of settings data to the second storage medium; and imaging the set of executable data to the second storage medium.

Some implementations include a method of managing data in a computing environment, the data including executable data, settings data, and user data, the method including: relocating the executable data, the settings data, and the user data to a secondary storage medium; reconfiguring the computing environment such that a user data access request is routed to the user data on the secondary storage medium; and modifying the computing environment such that the user data appears not to have been relocated.

Some implementations include a computer program product encoding a computer program for a computer process that executes on a computer system that manages data in a computing environment, the data including executable data, settings data, and user data, the computer process including: identifying a user data reference in the computing environment that references a located set of user data on the first storage medium, the user data reference having a user-perceivable label; changing the user data reference to reference a second storage location on a second storage medium, wherein the user-perceivable label is unchanged; and relocating the set of user data to the second storage location on the second storage medium.

Other implementations are also described and recited herein.

### BRIEF DESCRIPTIONS OF THE DRAWINGS

FIG. 1 illustrates an exemplary computing and operating environment framework.

FIG. 2 illustrates exemplary operations for applying an operating environment assurance tool to a computing system.

FIG. 3 illustrates an alternative set of exemplary operations for applying an operating environment assurance tool to a computing system.

FIG. 4 illustrates exemplary operations for performing a remount volume operation.

FIG. 5 illustrates exemplary operations for performing a data identification operation.

FIG. 6 illustrates exemplary operations for performing a data pointer modification operation.

FIG. 7 illustrates exemplary operations for performing a data loading operation.

FIG. 8 illustrates a dialog box of an exemplary operating environment assurance tool.

FIG. 9 illustrates exemplary operations for performing a data recovery operation.

FIG. 10 illustrates an exemplary system useful in implementations of the described technology.

### DETAILED DESCRIPTION

There are at least three distinct data types in a general purpose computing environment that may be functionally separated: executable data, settings data, and user data (collectively “environment data”), although less than three data types may be functionally separated in various implementations of a computing environment assurance tool. Executable data includes instructions that execute in memory such as software applications (e.g., the Microsoft Outlook email program) and operating system code (e.g., the Apple OS/X operating system). Settings data configures how executable data runs. A common example of settings data in the Windows operating system is data from the Windows registry. User data encompasses input, output and intermediate data on which the executable data operates. Examples of user data include: a text file containing a favorite recipe, a jpeg file containing a family photograph, and a video file containing a recording of a child's soccer game. Executable and settings data can be captured in a disk image (or any other suitable copying technique) of a computer's primary storage medium (e.g., a local hard drive) on some form of secondary storage media (e.g., a removable hard drive). Imaging the executable and settings data enables convenient backup and restoration of the data from the secondary storage medium. Imaging can be repeated at various intervals to provide updated backups. In addition, user data can be relocated to secondary storage media as well. This relocation to secondary storage functionally separates and makes recoverable all of the elements that are important to the typical user's computing environment. As such, the user's entire environment may be stored on secondary storage media, while what remains on the local computing system is disposable or replaceable from data stored on secondary storage media.

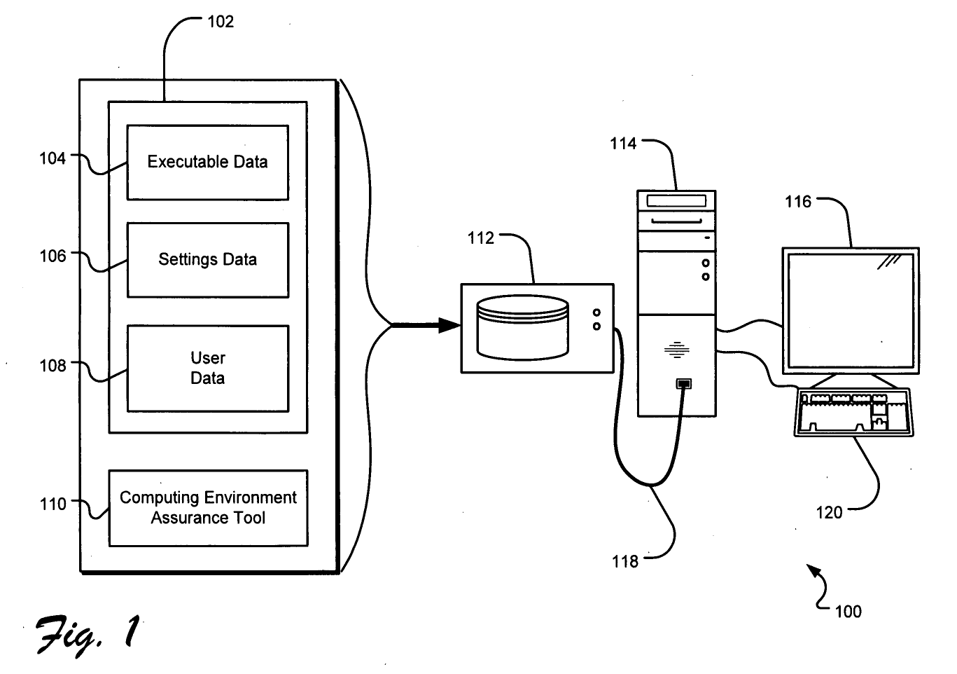

FIG. 1 illustrates an exemplary computing and operating environment framework 100 including a computer 114, viewing device 116, keyboard 120, and secondary storage medium 112. The secondary storage medium 112 is attached to the computer 114 via a USB cable 118. The secondary storage medium 112 contains the computing environment assurance tool 110 as well as the user's computing environment 102, which includes executable data 104, settings data 106, and user data 108 in the illustrated implementation. In a conventional computing environment, executable data, settings data, and user data are relatively unstructured and jumbled together on the primary storage medium. Application of a computing environment assurance tool structures and functionally separates the data onto a secondary storage medium 112.

The secondary storage medium 112 can be any type of storage device including, but not limited to, a hard drive, memory stick or card, PCMCIA drive, PC Card, PC Express Card, rewritable DVD drive, network drive, etc. It should be noted that faster storage devices will likely provide a more optimal experience for the user. Furthermore, the secondary storage medium 112 can be attached, inserted, or otherwise connected to the computer 114 using any current or future technologies including, but not limited to, Firewire, USB, Ethernet, wireless link, etc. The computing environment assurance tool 110 can reside on the secondary storage medium 112, on the primary storage medium local to the computer 114, on a non-local storage medium accessible via a network, on a CD-ROM disc, on a floppy disk, on a solid-state memory card, in the memory of the computer system, or on any other storage medium.

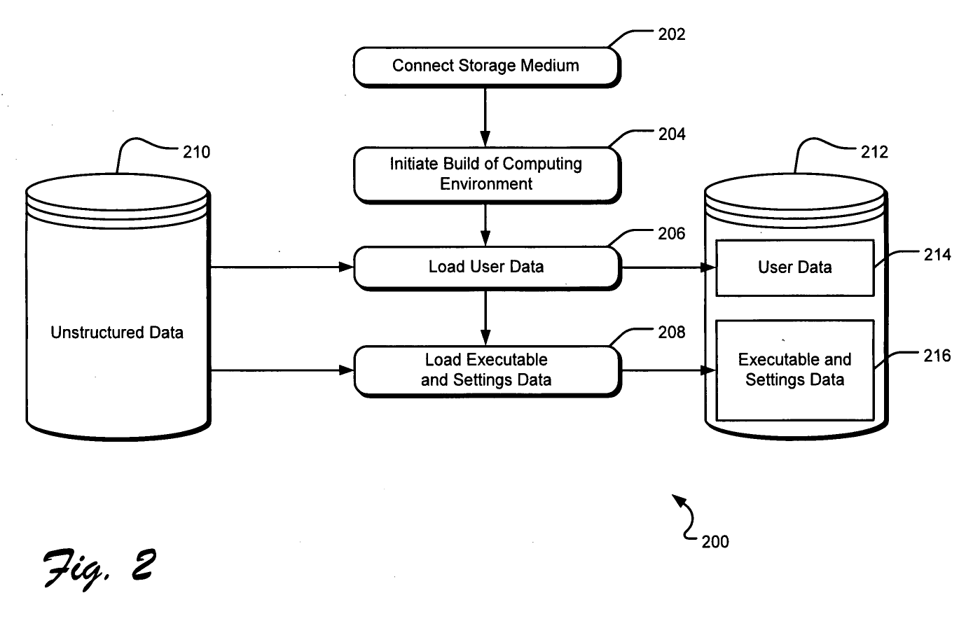

FIG. 2 illustrates an exemplary implementation of a computing environment assurance tool 200. Application of a computing environment assurance tool to a computing environment containing relatively unstructured data 210 results in a computing environment containing structured user data 214 and executable and settings data 216 on a secondary storage medium 212. In FIG. 2, the connecting operation 202 connects the secondary storage medium 212 to a computing system. The secondary storage medium 212 could be any type of storage medium including, but not limited to, a hard drive, memory stick or card, PCMCIA drive, PC Card, PC Express Card, rewritable DVD drive, network drive, etc. Furthermore, the method of attaching the secondary storage medium 212 to the computing system includes, but is not limited to, connecting, plugging, inserting, wirelessly linking, and otherwise interfacing the secondary storage medium 212 and the computing system.

The initiating operation 204 initiates the build of a computing environment on the secondary storage medium 212. It should be noted that FIG. 2 illustrates an exemplary application of a computing environment assurance tool to a computing environment and initiating the build of a computing environment 204 is only a single step in a larger overall process.

The load user data operation 206 examines the relatively unstructured data 210. There are many possible methods of examining the data 210 in order to identify executable data, settings data, and user data. In one implementation, the load user data operation 206 searches the data 210 for identifying characteristics in order to distinguish and locate the different types of data. In another implementation, the load user data operation 206 accesses metadata and uses the information contained therein to identify the data types. In the implementation illustrated in FIG. 2, only a single, relatively unstructured data repository 210 is displayed. In an alternate implementation, the computing environment can be spread out over multiple relatively unstructured data repositories. The load user data operation 206 relocates the identified unstructured user data onto a secondary storage medium 212 as structured user data 214. Although the implementation illustrated in FIG. 2 shows only a single secondary storage medium 212, multiple secondary storage media could be used in an alternate implementation.

The load executable and settings data operation 208 conducts further examination of the unstructured data 210 in order to identify executable data and settings data. In an alternate implementation, the load user data operation 206 identifies executable and settings data as well as user data. The load executable and settings data operation 208 searches the data 210 for identifying characteristics in order to distinguish and locate the different types of data. In yet another implementation, the load executable and settings data operation 208 accesses metadata and uses the information contained therein to identify the data types. The load executable and settings data operation 208 images the executable and settings data onto the secondary storage medium 212 as structured executable and settings data 216. In an alternate implementation, the load executable and settings data operation 208 utilizes any of a number of procedures that, though technologically similar to imaging, are distinct methods of relocating data (e.g., copy, backup, compress and copy, etc.). In yet another implementation, the executable data is imaged to a tertiary storage medium and the settings data is imaged to either the same tertiary storage medium or a quaternary storage medium. It is important to note that each of the three data types can be relocated to a single storage medium or to many storage media.

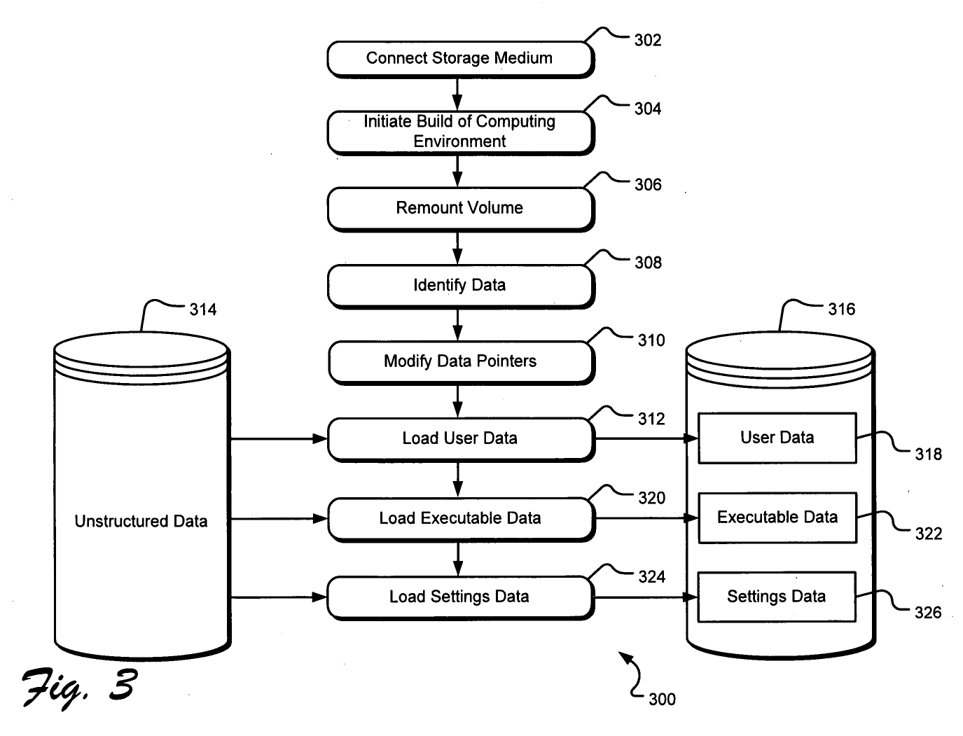

FIG. 3 illustrates an exemplary implementation of a computing environment assurance tool 300. Application of a computing environment assurance tool to a computing environment containing relatively unstructured data 314 results in a computing environment containing structured user data 318, executable data 322, and settings data 326 on a secondary storage medium 316. Once again, it is worthwhile to note that alternate implementations could involve one or more unstructured data repositories and one or more secondary storage media. In FIG. 3, the connecting operation 302 connects the secondary storage medium 316 to a computing system. As discussed above, the secondary storage medium 316 could be any type of storage medium including, but not limited to, a hard drive, memory stick or card, PCMCIA drive, PC Card, PC Express Card, rewritable DVD drive, network drive, etc. Furthermore, the method of attaching the secondary storage device to the computing system includes, but is not limited to, connecting, plugging, inserting, wirelessly linking, and otherwise interfacing the secondary storage medium and the computing system.

The initiating operation 304 initiates the build of a computing environment on the secondary storage medium 316. It should be noted that FIG. 3 illustrates an exemplary application of a computing environment assurance tool to a computing environment and initiating the build of a computing environment 304 is only a single step in a larger overall process.

The remount volume operation 306 examines the connection or “mount point” between the secondary storage medium 316 and the computing system. If the computer system has mounted the secondary storage medium 316, the remount volume operation 306 removes the mount point. If the computer system has not mounted the secondary storage medium 316, the remount volume operation 306 does not attempt to remove a non-existent mount point. Examples of mount points include drive letters, volume names, etc. The remount volume operation 306 creates a mount point for the secondary storage medium 316 that represents the location of the secondary storage medium 316 within the computing system.

The identify data operation 308 examines the relatively unstructured data 314 and identifies the data as user data, executable data, or settings data. There are many possible methods of identifying the data 314. In one implementation, the identify data operation 308 searches the data 314 for identifying characteristics in order to distinguish data by type as well as locate the types of data. In another implementation, the identify data operation 308 accesses metadata and uses the information contained therein to distinguish and locate the different types of data.

In yet another implementation, data locations are captured by examining the data pointers in a computer system. When the operating system, a program, or some process requests particular data, the data pointers tell the requestor where to look on the system's storage media to find the particular data. For example, a Windows XP system has one or more data pointers that reference the volume containing the “My Documents folder” on the primary hard drive. When a user accesses the My Documents folder, the pointers direct the request to the appropriate location on the primary hard drive in order to access the My Documents folder data. In an alternate implementation,

In the implementation illustrated in FIG. 3, the modify data pointers operation 310 reads existing data pointers for user data and modifies them to point to locations on the secondary storage medium 316 to which the user data will be relocated.

The load user data operation 312 relocates (e.g., a copy or a move operation) the user data identified in the identify data operation 308 from the original storage medium to the secondary storage medium 316 as structured user data 318. Thus, in the above My Documents folder example, once the relocation of user data (which includes the My Documents folder) has occurred, an attempt by the user to access the My Documents folder is directed by the data pointers to the appropriate location on the secondary storage medium. The user then “works” with the user data on the secondary storage medium. Once a user is working with user data on the secondary storage medium, if the computer system's primary hard drive fails, the user data is not lost.

In an alternate implementation, backups of the user data are made, perhaps periodically, on the primary and secondary storage media such that either can fail without the user losing his or her user data. In yet another implementation, the backup process incorporates a tertiary storage medium such that both the primary and secondary storage media can fail without causing the user to lose his or her user data.

The load executable data operation 320 reads the executable data that was identified in the identify data operation 308 and images it onto the secondary storage medium 316 as structured executable data 322. In an alternate implementation, the load executable data operation 320 utilizes any of a number of procedures that, though technologically similar to imaging, are distinct methods of relocating data (e.g., copy, backup, compress and copy, etc.). In yet another implementation, the executable data is imaged to a tertiary storage medium. It is important to note that each of the three data types can be relocated to a single storage medium or to many storage media.

The load settings data operation 324 reads the settings data that was identified in the identify data operation 308 and images it onto the secondary storage medium 316 as structured settings data 326. In an alternate implementation, the load settings data operation 324 utilizes any of a number of procedures that, though technologically similar to imaging, are distinct methods of relocating data (e.g., copy, backup, compress and copy, etc.). In yet another implementation, the settings data is imaged to a tertiary storage medium. It is important to note that each of the three data types can be relocated to a single storage medium or to many storage media.

In the implementation illustrated in FIG. 3, the executable data and settings data are loaded separately. In an alternate implementation, the executable data and settings data are loaded concurrently.

Once the data has been relocated onto a secondary storage medium 316, the storage medium 316 can be removed or otherwise disconnected from the original computing system and transported and connected to a different computing system. For example, a CEO of a multi-office company orders three computers, and places one in each her three offices. The CEO works for two months in the first office and then uses the computing environment assurance tool to relocate her user data, executable data and settings data to a secondary storage device. The next month, the CEO travels to her second office. She connects the secondary storage device to the second computer. The tool restores her executable and settings data to the second computer and allows access to her user data on the secondary storage device. In effect, the second computer has the same computing environment as her first computer. The process is repeated the next month when the CEO travels to her third office. Once again, simply by transporting her secondary storage medium she is able to replicate her original computing environment on the new computer.

In another implementation, the CEO uses the computing environment assurance tool twice to create two duplicate secondary storage media. If the CEO subsequently loses or destroys one of the media, she can still access her computing environment on the backup secondary storage medium.

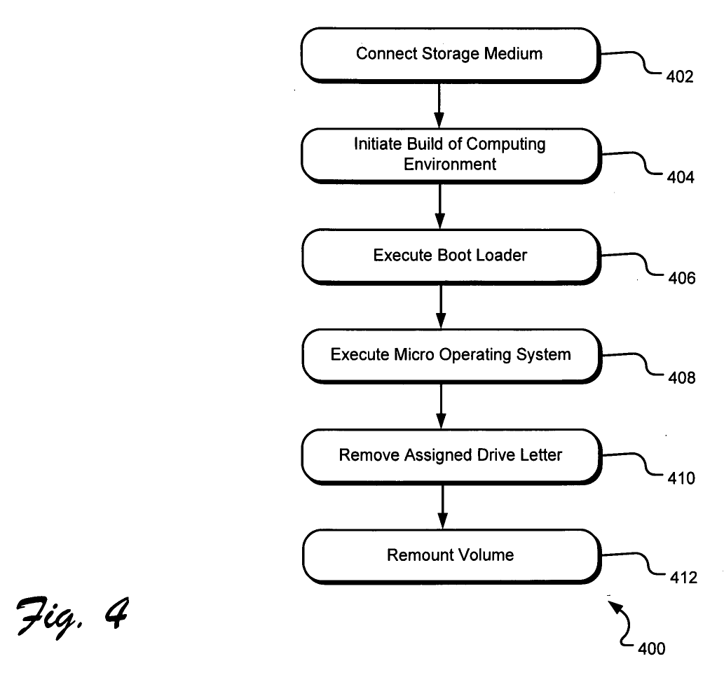

FIG. 4 illustrates an exemplary implementation of the remount volume operation 306 discussed in FIG. 3 above. The illustrated implementation 400 is initiated by the connect storage medium operation 402. In an alternate implementation, a user initiates the process manually by launching a program containing code for the tool, clicking on a Web link that downloads code for the tool and launches it, etc. In FIG. 4, the connecting operation 402 connects the secondary storage medium to a computing system. As discussed above, the implementation, the remount volume operation 412 may hide or obfuscate in some manner the new mount point that it creates in order to simplify the appearance of the system from a user perspective.

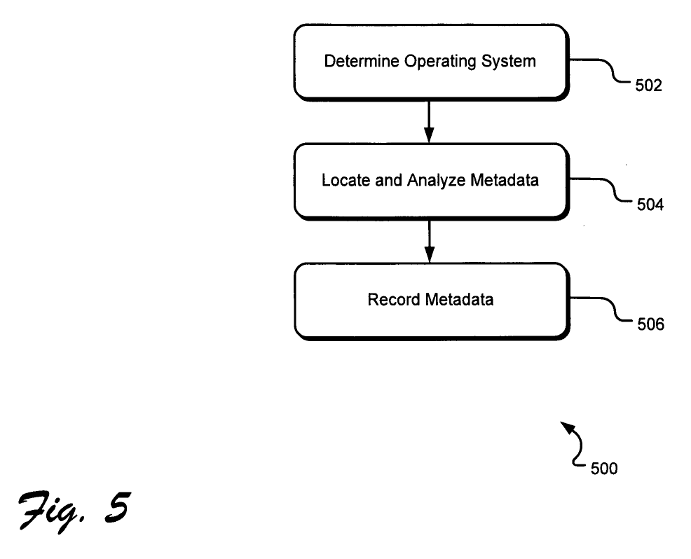

FIG. 5 illustrates an exemplary implementation of the identify data operation 308 discussed in FIG. 3 above. In the illustrated implementation 500, three operations are identified. In alternate implementations, the number of operations could be reduced or expanded. The determine operating system operation 502 examines the computing system in order to determine the type of operating system employed. Different operating systems often store and structure their metadata differently.

The locate and analyze metadata operation 504 compares the operating system information ascertained in the determine operating system operation 502 to a repository of known operating systems and their associated metadata characteristics. In one implementation, the locate and analyze metadata operation 504 utilizes a lookup table to find metadata characteristics associated with a particular operating system. In an alternate implementation, the locate and analyze metadata operation 504 accesses a network to retrieve appropriate metadata information. The locate and analyze metadata operation 504 also examines the metadata to determine data types (i.e., user data, executable data, and settings data) and locations.

The record metadata operation 506 writes metadata information to a storage location. In one implementation, the metadata is recorded in tabular format. A suitable table could include columns for data type, data name, original data location and new data location. The new data location column is completed during the modify data location operations 600. In another implementation, a metadata index is created so that the information contained in the metadata can be rapidly accessed when needed.

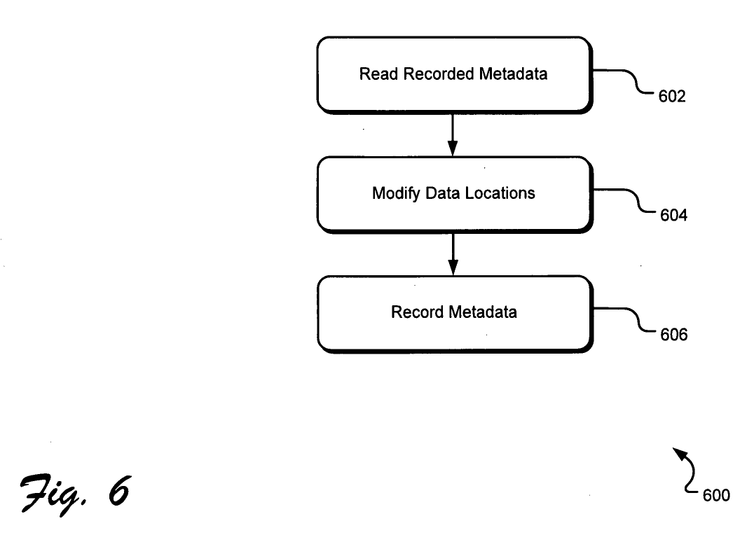

FIG. 6 illustrates an exemplary implementation of the modify data pointers operation 310 discussed in FIG. 3 above. In the illustrated implementation 600, three operations are identified. In alternate implementations, the number of operations could be reduced or expanded. The read recorded metadata operation 602 examines the metadata recorded during the identify data operations 500. As noted above, the recorded metadata can be newly created metadata or an index to the original metadata. The modify data locations operation 604 reads the original data pointers for the user data and modifies them to point to locations on the secondary storage medium to which the user data will be relocated. For example, the My Documents folder secondary storage medium could be any type of storage medium including, but not limited to, a hard drive, memory stick or card, PCMCIA drive, PC Card, PC Express Card, rewritable DVD drive, network drive, etc. Furthermore, the method of attaching the secondary storage medium to the computing system includes, but is not limited to, connecting, plugging, inserting, wirelessly linking, and otherwise interfacing the secondary storage medium and the computing system.

The initiating operation 404 initiates the build of a computing environment on the secondary storage medium. It should be noted that FIG. 4 illustrates an exemplary implementation of the remount volume operation and initiating the build of a computing environment 404 is only a single precursor step in a larger overall process.

The execute boot loader operation 406 launches a boot loader. The boot loader bypasses the operating system boot process on the primary hard drive of the computing system. In one implementation, the boot loader presents a user with a selection of boot options including executing a micro operating system. In another implementation, the boot loader launches the micro operating system directly. The execute micro operating system operation 408 eschews the primary hard drive operating system and instead launches a small operating system that is part of the computing environment assurance tool.

The execute micro operating system operation 408 examines the connection or “mount point” between the secondary storage medium and the computing system. Most computing systems automatically mount secondary storage media when they are attached or otherwise connected to the computing system.

The remove assigned driver letter operation 410 examines the mount point and determines its type. Examples of mount point types include drive letters (e.g., “d:\” and volume names (e.g., “\NewDrive\”). If the computing system automatically assigned a drive letter to the secondary storage medium, the remove assigned drive letter operation 410 removes the assigned drive letter. In another implementation, if the computing system assigned a volume name to the secondary storage medium, the remove assigned drive letter operation 410 removes the volume name.

The remount volume operation 412 creates a mount point for the secondary storage medium that represents the location of the secondary storage medium within the computing system. For example, in one implementation, the remount volume operation 412 could create a mount point called “\secondary_drive\” for the secondary storage medium. In another is of the “user data” type and the original location of the folder in the data pointer is “c:\documents and settings\user\my documents\”. The modify data locations operation 604 modifies the data pointer to reference the new location on the secondary storage medium: “\secondary storage medium\documents and settings\user\my documents\”.

The record metadata operation 606 writes the modified metadata to the storage medium. The operation writes both the updated data pointers as well as any associated metadata. Once the record metadata operation 606 is complete, an attempt to access user data will be directed by a modified data pointer to the secondary storage medium instead of the primary storage medium.

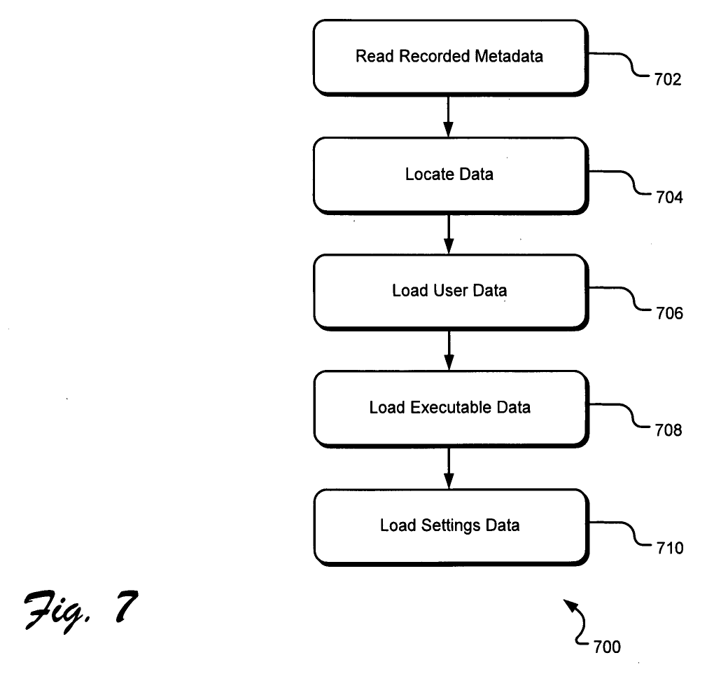

FIG. 7 illustrates an exemplary implementation of the load data processes 312, 320, and 324 discussed in FIG. 3 above. In the illustrated implementation 700, five operations are identified. In alternate implementations, the number of operations could be reduced or expanded. The read recorded metadata operation 702 examines the metadata recorded during the modify data operations 600. As noted above, the recorded metadata can be newly created metadata or an index to the original metadata. The locate metadata operation 704 uses the information retrieved during the read recorded metadata operation 702 to pinpoint the user data, executable data, and settings data on the primary storage medium. It is important to note that the primary storage medium can be one or more storage media.

The load user data operation 706 relocates (e.g., a copy or a move operation) the user data identified in the identify data operations 600 from the original storage medium to the secondary storage medium as structured user data. Once the relocation of user data (which includes the My Documents folder) has occurred, an attempt by the user to access the My Documents folder is directed by the data pointers to the appropriate location on the secondary storage medium. The user then “works” with the user data on the secondary storage medium. Once a user is working with user data on the secondary storage medium, if the computer system's primary storage medium fails, the user data is not lost. Although the description of the implementation in FIG. 7 refers only to a single secondary storage medium, multiple secondary storage media could be used in an alternate implementation.

The load executable data operation 708 accesses metadata and uses the information contained therein to image the executable data from the original storage medium to the secondary storage medium. In an alternate implementation, the load executable data operation 708 utilizes any of a number of procedures that, though technologically similar to imaging, are distinct methods of relocating data (e.g., copy, backup, compress and copy, etc.). In yet another implementation, the executable data is imaged to a tertiary storage medium. It is important to note that the executable data can be relocated to a single storage medium or to many storage media.

The load settings data operation 710 accesses metadata and uses the information contained therein to image the settings data from the original storage medium to the secondary storage medium. In an alternate implementation, the load settings data operation 710 utilizes any of a number of procedures that, though technologically similar to imaging, are distinct methods of relocating data (e.g., copy, backup, compress and copy, etc.). In yet another implementation, the settings data is imaged to a tertiary storage medium. It is important to note that the settings data can be relocated to a single storage medium or to many storage media.

In the implementation illustrated in FIG. 7, the user data, executable data and settings data are loaded separately. In an alternate implementation, the user data, executable data and settings data are loaded concurrently. In yet another implementation, two of the three data types are loaded concurrently and the third type is loaded separately.

Each of the load operations illustrated in FIG. 7 can occur more than once, thereby providing backup copies of the data types on any combination of the primary, secondary, or other storage medium. In another implementation, the load operations can be performed occasionally, periodically, or at a user's request in order to create a number of “snapshots” of the executable data, settings data, and user data.

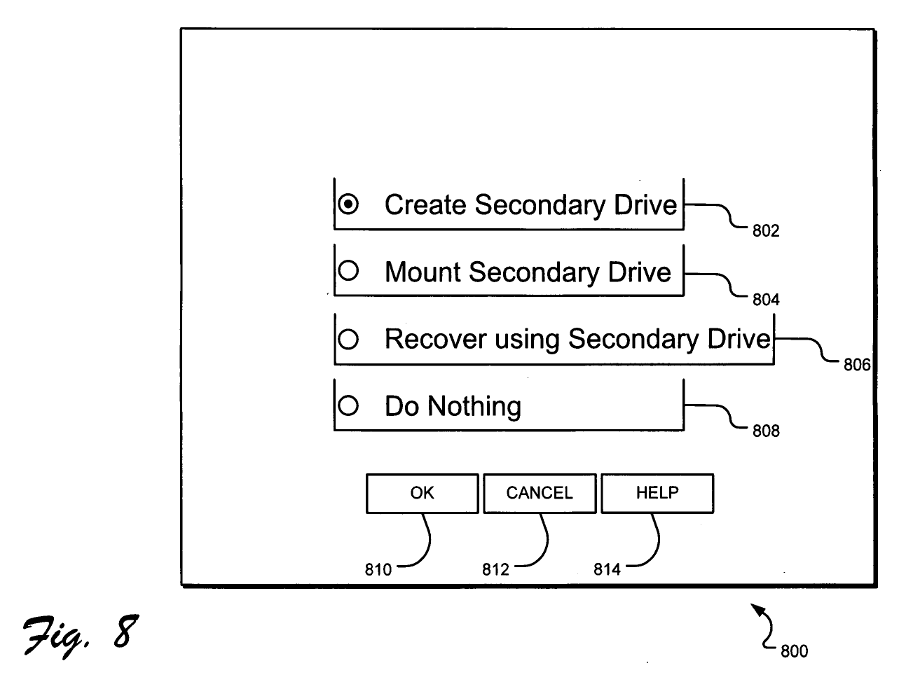

FIG. 8 illustrates an exemplary user interface dialog box 800 for a computing environment assurance tool. The dialog 800 is displayed whenever a secondary storage medium is attached, inserted, or otherwise connected to the computing system. Alternatively, the dialog 800 is displayed when the user launches the computing environment assurance tool. The dialog 800 contains four options: Create Secondary Drive 802, Mount Secondary Drive 804, Recover using Secondary Drive 806, and Do Nothing 808. The dialog also contains three buttons: OK 810, CANCEL 812, and HELP 814. It should be noted that other implementations could offer a different set of options and/or sub-options, as well as a different set of buttons. The Create Secondary Drive operation 802 relocates the user data onto the secondary drive and images the executable and settings data onto the secondary drive. The Mount Secondary Drive operation 804 mounts a previously created secondary drive and modifies the user data pointers to point to the user data on the secondary drive. The Recover using Secondary Drive operation 806 recovers executable or settings data that was previously imaged to the secondary drive. The Do Nothing operation 808 closes the dialog box 800 without initiating any further activity.

The Create Secondary Drive operation 802 allows a computer system user to initiate the conversion of a computing environment containing unstructured data into a computing environment containing structured data. User data is relocated to the secondary storage medium and user data pointers are modified to reference the new locations. Executable and settings data are imaged, copied, or otherwise relocated to the secondary storage medium.

The Mount Secondary Driver operation 804 allows a user to request that the newly added storage medium be mounted and that user data pointers be modified to point to the user data on the secondary storage medium. Following data pointer modification, future calls to user data (e.g., asking for a file listing for the My Documents directory) reference the secondary storage medium instead of the primary storage location. For example, a computer system has two users, User Alpha and User Beta. User Alpha stores all of her user data in a conventional manner on the computer system under the My Documents volume. User Beta has created a secondary storage medium containing his user data and one or more images of his executable and settings data. User Beta operates the computer system and opens the My Documents volume on the local storage medium. User Alpha's user data is displayed. User Beta connects his secondary storage medium to the system and is confronted with the user interface dialog 800. He chooses the Mount Secondary Drive operation 804 and selects the OK button 810. The system modifies the metadata references to user data so that they point to User Beta's user data on the storage medium. When User Beta again opens the My Documents volume, he now sees his own user data instead of the original User Alpha user data located in the original My Documents volume on the computer system's local storage medium.

The Recover using Secondary Drive operation 806 allows a user to restore executable and/or settings data to a computer system's local storage medium from a previously created secondary storage medium. For example, a computer system user experiences difficulties with the operation of her computing environment. She is confronted with the user interface dialog 800. The user chooses the Recover using Secondary Drive operation 806 and selects the OK button 810. In one implementation, the system recovers the most recent settings data from the secondary storage medium and restores the settings data to the local storage medium. If the user continues to experience difficulties, she can instruct the system to recover an earlier version of her settings data. Alternatively, the user instructs the system to recover both the executable and settings data from a time when the system was problem-free. Her executable and settings data are fully restored while her current user data remain available and usable.

The Do Nothing operation 808 allows the user to close the user interface dialog 800 without launching any system functionality. The desirability of the Do Nothing option is apparent when a user wants simply to access an external storage medium via the standard methods without accessing any of the options and benefits of the computing environment assurance tool. The Cancel button 812 also closes the dialog 800 without initiating any further action. The Help button 814 displays a help screen that explains each of the above functions.

The computer system boots 902 and the user selects a boot device 904. A micro operating system is executed 906 and it presents a user with recovery options 908. The user chooses options and a recovery is performed 910. If the resulting computing environment is still unstable, the user can repeat the process and recover an earlier version of her settings data and/or executable data. When a stable, trouble-free system is restored, the recovery process ends.

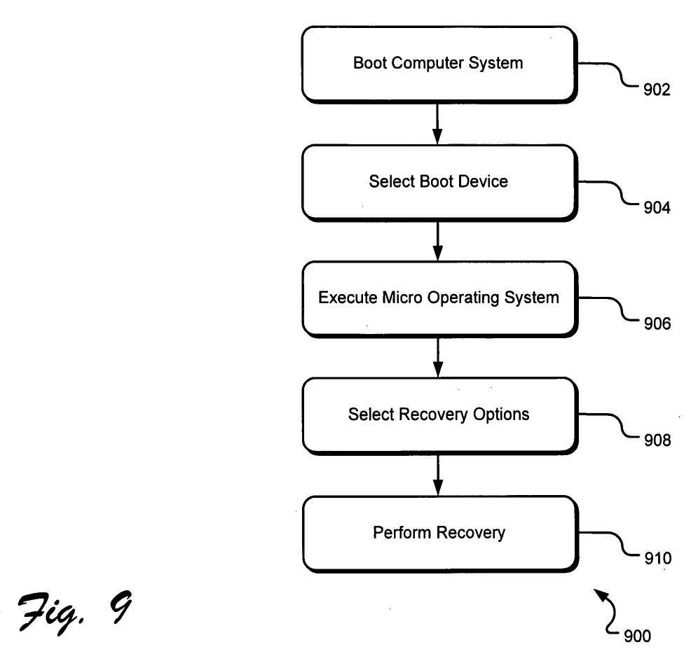

FIG. 9 illustrates another exemplary implementation of the Recover using Secondary Drive operation 806. The illustrated implementation 900 is initiated by the user choosing the Recover using Secondary Drive operation 806 and pressing the OK button 810. The boot computer system operation 902 causes the computer system to reboot. After reboot, the select boot device operation 904 occurs. The select boot device operation 904 allows the user to bypass the operating system boot process on the primary hard drive of the computing system and instead select a micro operating system. In another implementation, the select boot device operation 904 automatically launches the micro operating system directly. The execute micro operating system operation 906 eschews the primary hard drive operating system and instead launches a small operating system that is part of the computing environment assurance tool.

The execute micro operating system operation 906 examines the secondary storage medium and the computing system and presents the user with recovery options. In an alternate implementation, the micro operating system presents no options to the user and instead presents the perform recovery operation 908 with variables representing default options. The perform recovery operation 908 accepts the user selected options (or the default options) and recovers the data accordingly. Examples of user selected options include, but are not limited to: recover the most recent settings data only, recover the second newest settings data, recover both the settings data and executables data from last week, etc.

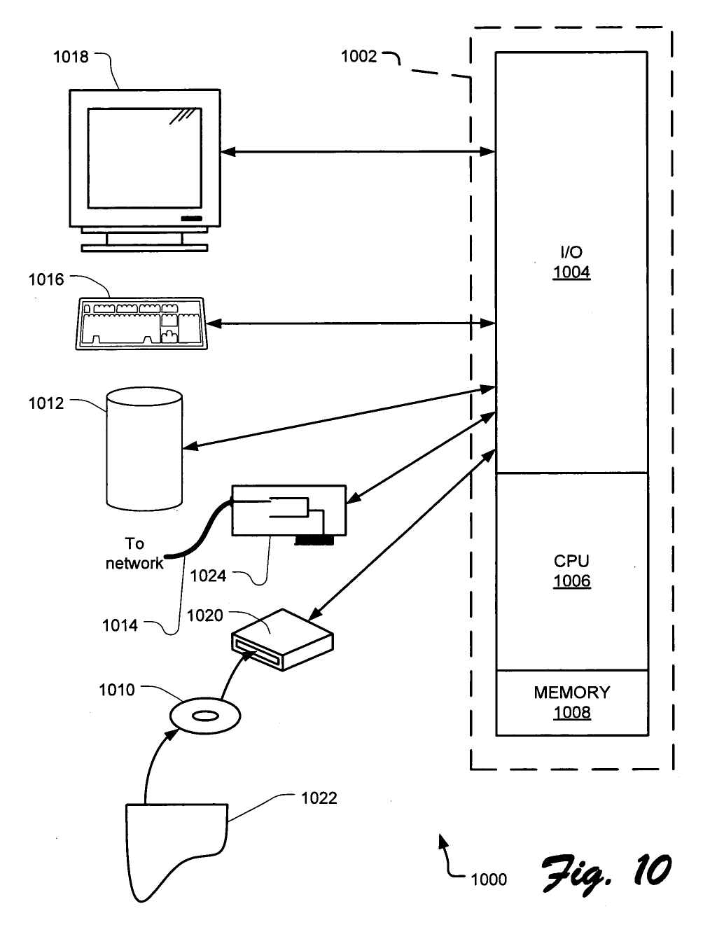

FIG. 10 illustrates an exemplary system useful in implementations of the described technology. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 10 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 10 into a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1008, on a disk storage unit 1012, or on the DVD/CD-ROM medium 1010 of such a system 1000. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward creating and maintaining a computing environment assurance tool and associated operations may reside on the disk storage unit 1012, disk drive unit 1020 or other storage medium units coupled to the system. Said software instructions may also be executed by CPU 1006.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of managing data in a computing environment, the data including executable data, settings data, and user data, the method comprising:
identifying a user data reference in the computing environment that references a located set of user data on a first storage medium, the user data reference having a user-perceivable label;
changing the user data reference to reference a second storage location on a second storage medium, wherein the user-perceivable label is unchanged; and
relocating the set of user data to the second storage location on the second storage medium.

2. The method of claim 1 further comprising:
imaging a set of executable data to the second storage medium.

3. The method of claim 1 further comprising:
imaging a set of settings data to the second storage medium.

4. The method of claim 1 further comprising:
identifying a set of executable data on one or more of the first storage medium and the second storage medium.

5. The method of claim 1 further comprising:
identifying a set of one or more of executable data, settings data, and user data on one or more of the first storage medium and the second storage medium.

6. A method of structuring data in a computing environment, the data including executable data, settings data, and user data, the method comprising:
identifying a set of user data on a first storage medium;
identifying a set of settings data on the first storage medium;
identifying a set of executable data on the first storage medium;
changing one or more pointers for the set of user data on the first storage medium to reference a second storage medium;
relocating the set of user data referenced by the one or more pointers from the first storage medium to the second storage medium;
modifying the computing environment such that the set of user data appears not to have been relocated;
imaging the set of settings data to the second storage medium; and
imaging the set of executable data to the second storage medium.

7. The method of claim 6 further comprising:
recovering the set of settings data from the second storage medium to the first storage medium.

8. The method of claim 6 further comprising:
recovering the set of executable data from the second storage medium to the first storage medium.

9. A method of managing data in a computing environment, the data including executable data, settings data, and user data, the method comprising:
relocating the executable data, and the user data to a secondary storage medium;
reconfiguring the computing environment such that a user data access request is routed to the user data on the secondary storage medium; and
modifying the computing environment such that the user data appears not to have been relocated.

10. A computer program product encoding a computer program for a computer process that executes on a computer system that manages data in a computing environment, the data including executable data, settings data, and user data, the computer process comprising:
identifying a user data reference in the computing environment that references a located set of user data on the first storage medium, the user data reference having a user-perceivable label;
changing the user data reference to reference a second storage location on a second storage medium, wherein the user-perceivable label is unchanged; and
relocating the set of user data to the second storage location on the second storage medium.

11. The method of claim 10 further comprising:
imaging a set of executable data to the second storage medium.

12. The method of claim 10 further comprising:
imaging a set of settings data to the second storage medium.
